(19) United States
(12) Patent Application Publication
(10) Pub. No.: US 2006/0274415 A1
(43) Pub. Date: Dec. 7, 2006

(54) Inexpensive polarizer having high polarization characteristic

(75) Inventor: Hisashi Murata, Fukushima-ken (JP)

Correspondence Address: BEYER WEAVER & THOMAS, LLP, P.O. BOX 70250, OAKLAND, CA, 94612-0250, US

(73) Assignee: ALPS ELECTRIC CO., LTD.

(21) Appl. No.: 11/408,865

(22) Filed: Apr. 21, 2006

(30) Foreign Application Priority Data
May 25, 2005 (JP) 2005-151871

(51) Int. Cl. G02B 5/30

(52) U.S. Cl. 359/486

(57) ABSTRACT

A polarizer includes a substrate and a fine grid which is made of a metallic material and is formed on a surface of the substrate. The substrate has a plurality of projections formed on the surface thereof which have substantially mountain shapes in sectional view and are arranged at a predetermined height and predetermined pitches. A metal layer is formed on one inclined surface of each of the mountain-shaped projections, thereby forming the fine grid. The pitch of the metal layer is set to ½ or more of the wavelength of light used, and the height of the metal layer is set to ⅕ or more of the wavelength of the light used.

### BACKGROUND OF THE INVENTION

1. Field of the Invention

The present invention relates to a polarizer controlling the polarization of incident light, and in particular, to a polarizer controlling the polarization of incident light by a diffraction phenomenon.

2. Description of the Related Art

Polarizers used in a visible light wavelength range or the vicinity thereof have been extensively used for displays or optical pick-up devices and have been required to have high performance and low manufacturing costs. Two types of polarizers are known from the viewpoint of the principle of polarization: a polarizer using absorption anisotropy based on fine metal; and a polarizer using a diffraction phenomenon based on the strict relationship between the height and the period of a metal grid.

The polarizer using absorption anisotropy is required to have a multi-layer structure because a single layer structure has a low optical extinction ratio. Further, since the polarizer uses absorption, it has a good polarization characteristic with respect to transmission light, but it cannot use the polarization characteristic with respect to reflection light. Meanwhile, in the polarizer using the diffraction phenomenon, even though the polarizer has a single layer structure, it is possible to obtain a good polarization characteristic and to obtain a high optical extinction ratio with respect to reflection light. An example of the polarizer using the diffraction phenomenon is disclosed in WO/079317.

However, in the polarizer using the diffraction phenomenon, it is required to precisely process the pitch and the height of a very fine metal grid, which makes the process difficult. FIG. 6 is an enlarged sectional view showing the vicinity of a surface of a polarizer according to the related art. As shown in FIG. 6, the polarizer according to the related art has a substrate 100 and a metal grid 101 that is formed on the substrate 100 by arranging a plurality of metal layer 102 having a predetermined height at predetermined pitches.

In the polarizer shown in FIG. 6, the wavelength of light used is set to 500 nm and the pitch of the metal layers 102 constituting the metal grid 101 is set to 0.14 μm. FIGS. 7A and 7B show the height dependence of the metal grid 101 of the polarizer. FIG. 7A shows a polarization characteristic with respect to a TM (transverse magnetic) wave, and FIG. 7B shows a polarization characteristic with respect to a TE (transverse electric) wave. Further, the TM wave refers to polarized light in which an electric field vector is oriented in a direction perpendicular to the direction where the grid is arranged, and the TE wave refers to polarized light in which an electric field vector is oriented in a direction parallel to the direction where the grid is arranged.

As shown in FIG. 7A, the larger the height of the metal grid 101, the better the characteristic of the TM wave. Meanwhile, as shown in FIG. 7B, the polarization characteristic of the TE wave periodically varies according to the height of the metal grid 101. Therefore, in order to obtain a good characteristic, it is required to more accurately form the height of the metal grid 101. In a case of the polarizer shown in FIG. 6, the tolerance for obtaining enough performance is about 20 nm, as can be seen from FIG. 7.

In the polarizer according to the related art, the fine metal grid is formed on the substrate by photolithographic and etching processes. However, when the tolerance is about 20 nm, it is necessary to use an expensive apparatus for processing. Therefore, the process cost increases.

### SUMMARY OF THE INVENTION

The invention has been made in view of the above-mentioned problems, and it is an object of the invention to provide an inexpensive polarizer having an excellent polarization characteristic.

In order to achieve the object, according to an aspect of the invention, a polarizer includes a substrate and a fine grid which is made of a metallic material and is formed on the substrate. In the polarizer, the substrate has a plurality of projections formed on a surface thereof which have substantially mountain shapes in sectional view and are arranged at a predetermined height and predetermined pitches. A metal layer is formed on one inclined surface of each of the mountain-shaped projections, thereby forming the fine grid. The pitch of the metal layer is set to ½ or more of the wavelength of light used, and the height of the metal layer is set to ⅕ or more of the wavelength of the light used.

In the polarizer according to this aspect of the invention, it is preferable that the metal layer be formed of aluminum or silver.

Further, in the polarizer according to this aspect of the invention, it is preferable that the substrate have the fine grids on both surfaces.

Furthermore, in the polarizer according to this aspect of the invention, it is preferable that a plurality of substrates each having the fine grid on one or both surfaces be laminated.

### BRIEF DESCRIPTION OF THE DRAWINGS

FIG. 1 is an enlarged sectional view showing the vicinity of a surface of a polarizer according to an embodiment;

FIGS. 2A and 2B are views illustrating the height dependence of a grid of the polarizer according to the embodiment;

FIGS. 3A and 3B are views illustrating the height dependence of the grid of the polarizer according to the embodiment;

FIGS. 4A and 4B are views illustrating the wavelength dependence of the polarizer according to the embodiment;

FIGS. 5A and 5B are views illustrating processes of manufacturing the polarizer according to the embodiment;

FIG. 6 is an enlarged sectional view showing the vicinity of a surface of a conventional polarizer; and

FIGS. 7A and 7B are views illustrating the height dependence of a grid of the conventional polarizer.

### DESCRIPTION OF THE PREFERRED EMBODIMENT

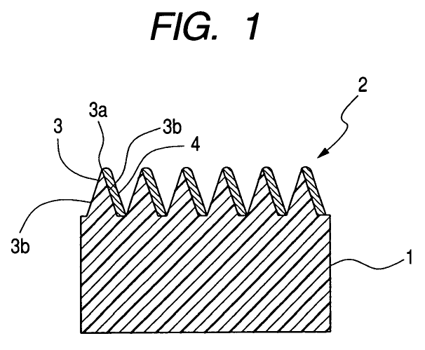

A preferred embodiment of the invention will now be described in detail with reference to the drawings. A polarizer according to this embodiment includes a substrate 1 made of a transparent optical resin and a metal grid 2 formed on the substrate 1. The metal grid 2 is formed by arranging a plurality of metal layers 4 having a predetermined height on the substrate with predetermined pitches. The substrate 1 also can be made of PMMA, PC, PET, or a general-purpose transparent resin. FIG. 1 is an enlarged sectional view showing the vicinity of a surface of the polarizer according to this embodiment.

As shown in FIG. 1, the substrate 1 has a plurality of projections 3 with a substantially mountain-shaped section formed thereon. The projections 3 are formed in linear shapes having substantially the same section in the longitudinal direction. Further, the projections 3 are formed to have almost the same height and pitch as those of the metal grid 2, and to have inclined planes 3b on the left and right sides of their vertexes 3a.

The metal layer 4 is formed on one inclined plane 3b of each projection 3 by depositing aluminum. The metal layers 4 are formed on the inclined planes 3b of all the projections 3 on the same side. The metal layers 4 are provided on the inclined planes 3b of the projections 3 which are arranged at a predetermined height and a predetermined pitch, thereby forming the metal grid 2 having a predetermined height and a predetermined pitch.

In this embodiment, the metal layer 4 is made of aluminum, but it may be made of, for example, silver, gold, or copper. In this embodiment, the surface of the substrate 1 has a substantially mountain shape having acute-angled vertexes 3a in sectional view. However, on the surface of the substrate 1, the vertexes 3a may be formed to have sine wave shapes in sectional view, which makes it possible to obtain required practical functions.

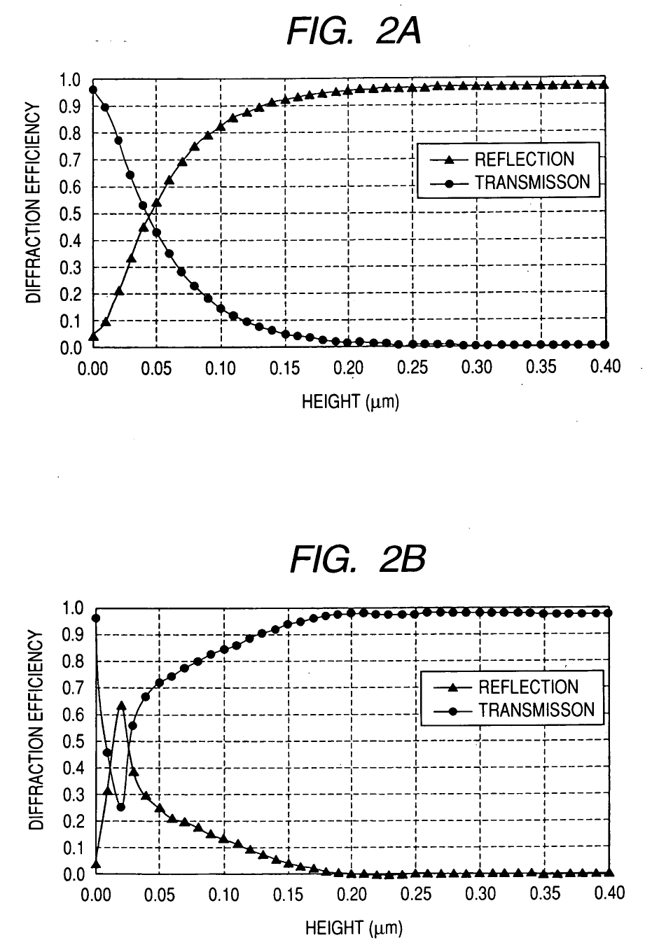

The polarizer according to this embodiment uses a wavelength within a visible light wavelength range of 400 nm to 700 nm. FIGS. 2A and 2B show polarization characteristics with respect to the height of the metal grid 2. FIG. 2A shows light transmission and reflection characteristics with respect to a TM wave, and FIG. 2B shows light transmission and reflection characteristics with respect to a TE wave. FIGS. 2A and 2B show the characteristics when the pitch of the metal grid 2 is fixed to 0.14 μm and light having a wavelength of 500 nm is incident at an incident angle of 0°. Further, the thickness of the metal layer 4 is 21 nm which corresponds to 15% of the pitch.

As shown in FIG. 2A, in a case of the TM wave, the larger the grid height, the higher the reflection efficiency and the lower the transmission efficiency. Therefore, the polarization characteristic is excellent. Further, as shown in FIG. 2B, in a case of the TE wave, except for an area where the grid height is small, the larger the grid height, the lower the reflection efficiency and the higher the transmission efficiency. Therefore, the polarization characteristic is excellent. FIGS. 2A and 2B show that it is possible to obtain 90 percent or more polarization efficiency when the grid height is 0.15 μm and to obtain 95 percent or more polarization efficiency when the grid height is 0.2 μm or more.

A periodic variation in the polarization characteristic with respect to the TE wave rarely occurs in the polarizer according to the invention, as compared with a conventional polarizer shown in FIG. 6. Therefore, when the grid height is larger than a predetermined value, a little error occurs, but a remarkable variation in polarization characteristics does not occur. For this reason, it is possible to take a large tolerance.

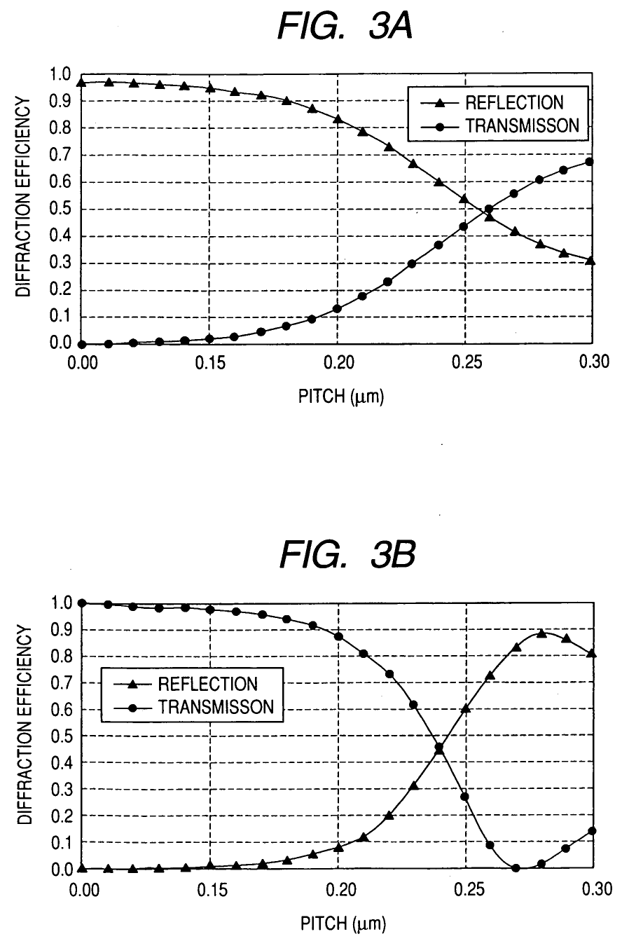

FIGS. 3A and 3B show polarization characteristics with respect to the pitch of the metal grid 2. FIG. 3A shows light transmission and reflection characteristics with respect to a TM wave, and FIG. 3B shows light transmission and reflection characteristics with respect to a TE wave. FIGS. 3A and 3B show the characteristics when the height of the metal grid 2 is fixed to 0.2 μm and light having a wavelength of 500 nm is incident at an incident angle of 0°. Further, the thickness of the metal layer 4 is 21 nm, similar to the structure shown in FIG. 2.

As shown in FIG. 3A, in a case of the TM wave, the larger the pitch of the metal grid 2, the higher the reflection efficiency and the lower the transmission efficiency. Therefore, the polarization characteristic is excellent. Further, as shown in FIG. 3B, in a case of the TE wave, except for an area where the pitch of the metal grid 2 is large, the smaller the pitch of the metal grid 2, the lower the reflection efficiency and the higher the transmission efficiency. Therefore, the polarization characteristic is excellent. FIGS. 3A and 3B show that it is possible to obtain 80 percent or more polarization efficiency when the pitch of the metal grid 2 is 0.2 μm and to obtain 95 percent or more polarization efficiency when the pitch of the metal grid 2 is 0.15 μm or less.

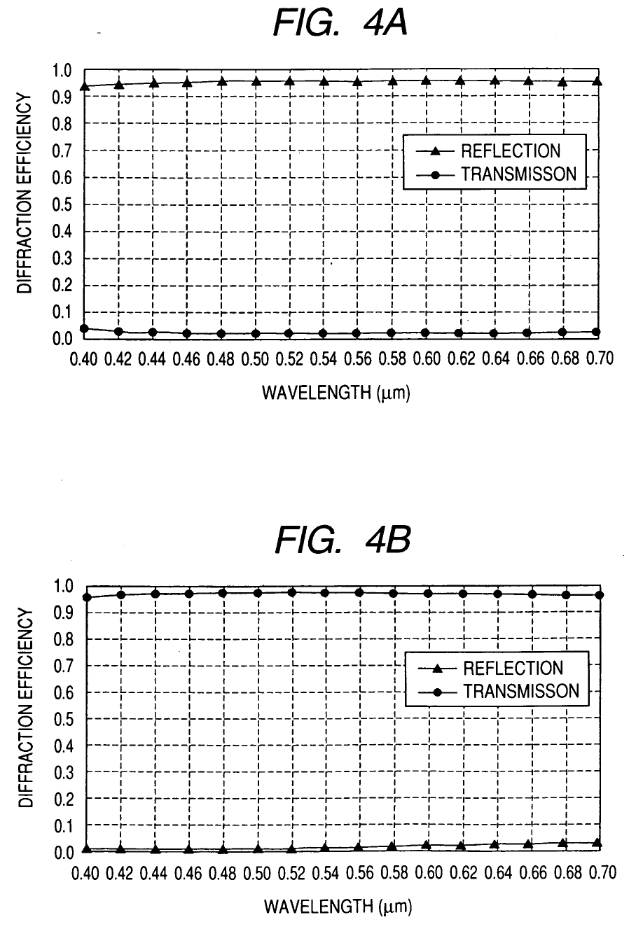

FIGS. 4A and 4B show polarization characteristics with respect to the wavelength of the incident light. FIG. 4A shows light transmission and reflection characteristics with respect to a TM wave, and FIG. 4B shows light transmission and reflection characteristics with respect to a TE wave. FIGS. 4A and 4B show the polarization characteristics when the height and the pitch of the metal grid 2 are fixed to 0.2 μm and 0.14 μm, respectively, and light is incident at an incident angle of 0°. As shown in FIGS. 4A and 4B, even though the wavelength varies within the visible light wavelength range of 400 nm to 700 nm, it does not have a much effect on the polarization characteristics. Therefore, it is possible to obtain an excellent polarization characteristic.

As described above, the polarizer according to the invention has small wavelength dependence in the visible light wavelength range. Therefore, as shown in FIGS. 2A and 2B and FIGS. 3A and 3B, when the height of the metal grid 2 is 0.15 μm or more and the pitch of the metal grid 2 is 0.2 μm or less, it is possible to obtain sufficient polarization efficiency with respect to visible light. As a result, for a wavelength range of 400 nm to 700 nm, when the height of the metal grid 2 is set to almost ⅕ or more of the maximum wavelength, 700 nm, and the pitch of the metal grid 2 is set to almost ½ or less of the minimum wavelength, 400 nm, it is possible to obtain enough characteristics required for a polarizer using a diffraction phenomenon.

Further, the thickness of the metal layer 4 is set to 21 nm corresponding to 15% of the pitch, as described above. However, when the thickness of the metal layer 4 is set to 14 nm corresponding to 10% of the pitch, the dependence of the TM wave on the grid height gently rises a little. For this reason, in order to obtain the same characteristics as those in the case in which the thickness is 21 nm, it is required to set the height of the metal grid 2 high. Therefore, it is preferable to set the thickness of the metal layer 4 to 10% or more of the pitch of the metal grid 2.

In order to improve environment resistance of the metal layer 4, a surface protecting layer (not shown) can be formed on the surface of the metal layer 2. The surface protecting layer can be composed of a dielectric thin film. When the surface protecting layer is formed with a thickness of about 3 nm, it is possible to improve the environment resistance of the metal layer 4 without affecting the polarization characteristic.

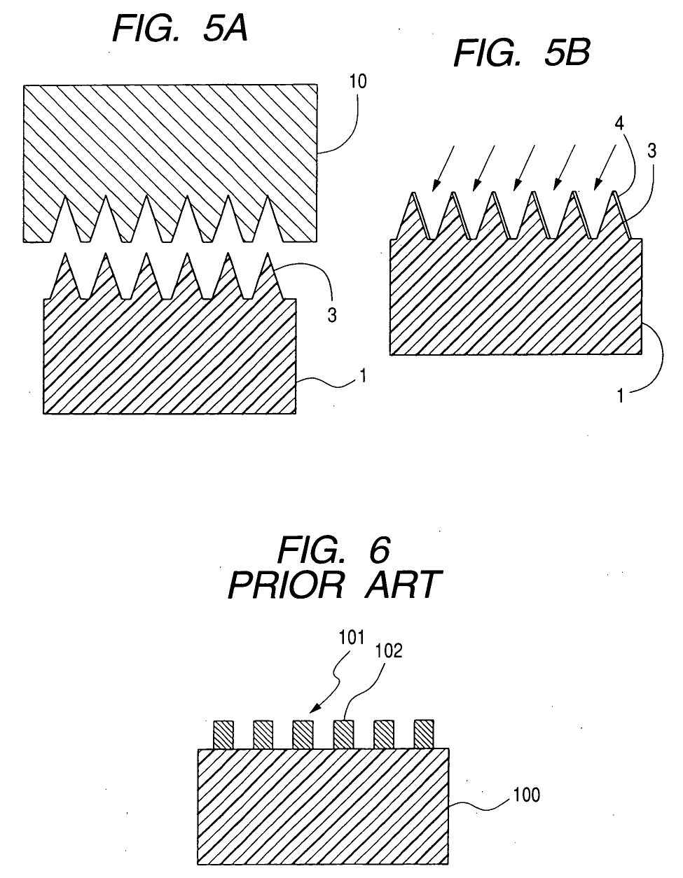

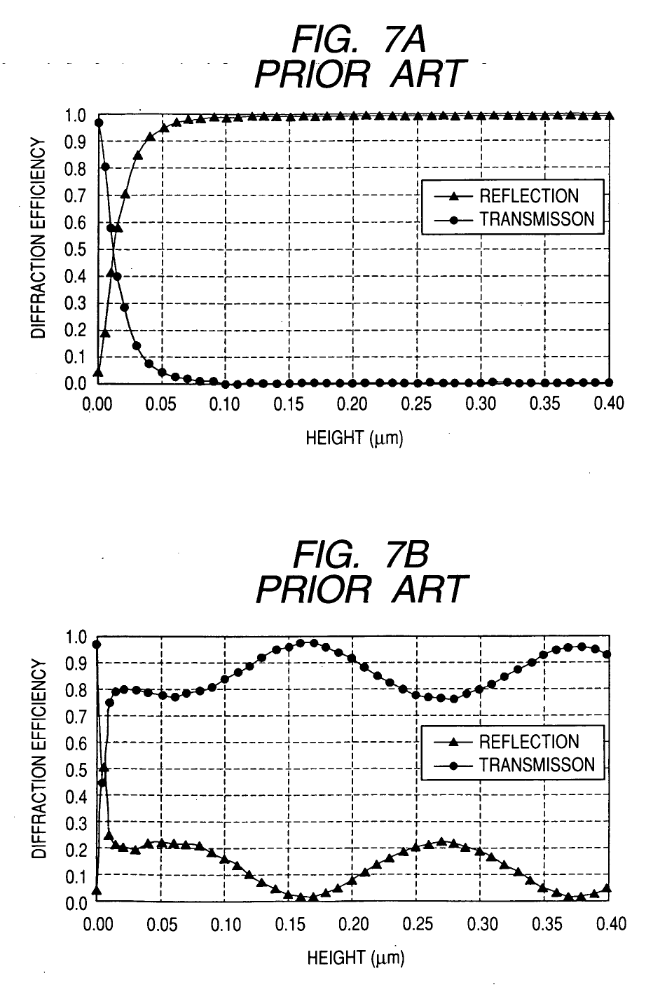

Next, a method of manufacturing the polarizer according to this embodiment will be described. FIGS. 5A and 5B are views showing processes of manufacturing the polarizer according to this embodiment. FIG. 5A illustrates forming the substrate 1. As shown in FIG. 5A, the projections 3 are formed on the substrate 1 by transferring a projection pattern on a surface of the substrate by using a die having a pattern thereon reverse to the projections 3. The surface shape of the die can be transferred onto the substrate 1 by, for example, an injection molding method, a photo-curing method, or a heat press method.

The die 10 having a fine pattern on a surface can be formed by directly cutting a metal substrate by using a cutting diamond tool. Further, the following method can be used: anisotropic etching is performed on a silicon substrate to make the vertexes have acute angles, thereby forming V-shaped grooves, and nickel electroforming is performed on the substrate to form a nickel die. Furthermore, when the groove has a high aspect ratio, a grayscale mask is formed by processing a resist by an EB method and then a silicon substrate is etched to form a master substrate. The nickel electroforming is performed on the master substrate to form a nickel die.

FIG. 5B illustrates forming the metal layer 4 on the substrate 1 where the projections 3 are formed. As shown in FIG. 5B, the metal layer 4 is formed by depositing aluminum on the surface of the substrate 1. In order to deposit aluminum only on one inclined surface 3b of two inclined surfaces 3a and 3b constituting each projection 3, an inclination deposition method in which the substrate 1 is disposed to be inclined to the flow of particles from an evaporation source is used. In this case, it is possible to deposit aluminum on only the one inclined surface 3b to form the metal layer 4 by disposing the substrate at an appropriate angle and appropriately disposing the evaporation source in accordance with the inclination angle of the inclined surface 3b constituting each projection 3.

The embodiment according to the invention has been described above. However, the invention is not limited to the embodiment, but various modifications and changes of the invention can be made within the scope and spirit of the invention. In the polarizer of the invention, the die 10 sequentially may transfer fine shapes onto the substrate 1 while moving from region to region, which makes it possible to manufacture a large-area polarizer irrespective of the size of the die 10. In this case, the substrate 1 may be composed of a flexible film to improve the releasability. Further, since the projection 3 has substantially a mountain shape in sectional view, the die 10 may be formed in a cylindrical shape and transfer the shape of the metal grid 2 onto the surface of the substrate 1 while rotating.

According to the invention, a polarizer includes a substrate and a fine grid which is made of a metallic material and is formed on the substrate. The substrate has a plurality of projections formed on a surface thereof which have substantially mountain shapes in sectional view and are arranged at a predetermined height and predetermined pitches, and a metal layer is formed on one inclined surface of each of the mountain-shaped projections, thereby forming the fine grid. The pitch of the metal layer is set to ½ or more of the wavelength of light used, and the height of the metal layer is set to ⅕ or more of the wavelength of the light used. Therefore, it is possible to manufacture a polarizer using a diffraction phenomenon at a low cost by a transfer technique using a die, and to obtain an enough polarization characteristic in a visible light range.

Further, in the polarizer according to the invention, the metal layer is formed of aluminum or silver. Therefore, it is possible to easier obtain the polarization characteristic.

Furthermore, in the polarizer according to the invention, the substrate has the fine grids on both surfaces. Therefore, it is possible to obtain an excellent polarization characteristic by raising the optical extinction ratio on both sides of the substrate.

In addition, in the polarizer according to the invention, a plurality of substrates each having the fine grid on one or both surfaces are laminated. Therefore, it is possible to obtain an excellent polarization characteristic by raising the optical extinction ratio on the surfaces of the plurality of substrates.

1. A polarizer comprising:
a substrate; and
a fine grid which is made of a metallic material and is formed on the substrate,
wherein the substrate has a plurality of projections formed on a surface thereof which have substantially mountain shapes in sectional view and are arranged at a predetermined height and predetermined pitches,
a metal layer is formed on one inclined surface of each of the mountain-shaped projections, thereby forming the fine grid, and
the pitch of the metal layer is set to ½ or more of the wavelength of light used, and the height of the metal layer is set to ⅕ or more of the wavelength of the light used.

2. The polarizer according to claim 1,
wherein the metal layer is formed of aluminum or silver.

3. The polarizer according to claim 1,
wherein the substrate has the fine grids on both surfaces.

4. The polarizer according to claim 1,
wherein a plurality of substrates each having the fine grid on one or both surfaces are laminated.
